(19) United States
(12) Patent Application Publication
(10) Pub. No.: US 2021/0182061 A1
(43) Pub. Date: Jun. 17, 2021

(54) INFORMATION PROCESSING DEVICE, INFORMATION PROCESSING METHOD, AND PROGRAM

(71) Applicant: NEC Corporation, Minato-ku, Tokyo (JP)

(72) Inventor: Osamu DAIDO, Tokyo (JP)

(73) Assignee: NEC Corporation, Minato-ku, Tokyo (JP)

(21) Appl. No.: 17/269,423

(22) PCT Filed: Aug. 22, 2018
(86) PCT No.: PCT/JP2018/030994

§ 371 Date: Feb. 18, 2021

(51) Int. Cl. G06F 9/30; G06F 9/38; G06N 20/00

(52) U.S. Cl. CPC G06F 9/30032; G06N 20/00; G06F 9/3887; G06F 9/30036

(57) ABSTRACT

An information processing device for acquiring a data sequence as an input and outputting a bit vector includes an input data sequence division unit configured to divide the data sequence into a plurality of groups, a bit shift unit configured to shift a digit of a value of data in each of the plurality of groups to a specific digit corresponding to each of the plurality of groups according to parallel processing in a single instruction multiple data (SIMD) method, and a bit setting unit configured to set the value of the data whose digits are shifted by the bit shift unit to corresponding digits of the bit vector.

### TECHNICAL FIELD

The present invention relates to an information processing device, an information processing method, and a program.

### BACKGROUND ART

In order to execute processing for a large amount of data at a high speed, it is important to use an acceleration technology based on hardware and an acceleration technology based on software in combination.

A method of accelerating processing by converting a data sequence into a bit vector when types of values that can be used as individual elements of the data sequence are very limited, for example, when a data sequence composed of only two values of {0,1} is processed, or the like, is known. In a bit vector, only meaningful bits are extracted from each element of an original data sequence, and the data sequence is expressed by a sequence of the bits. For example, when a data sequence is composed of only two values of {0,1}, since a meaningful part of the data sequence is only one bit in each element, one element of the original data sequence can be expressed by one bit of a bit vector. It is not necessary to prepare a specific data structure to handle the bit vector using a processor, and a simple integer-type array is often used.

Patent Document 1 discloses, as a related technology, a technology related to a method of using a bit vector when a query with a complex conditional clause is executed on a database.

Patent Document 2 discloses, as a related technology, a technology related to a method of using a bit vector in learning of a support vector machine (SVM).

### PRIOR ART DOCUMENTS

### Patent Document

[Patent Document 1]
Japanese Patent No. 6305406
[Patent Document 2]
Japanese Patent No. 6055391

### SUMMARY OF INVENTION

### Technical Problem

In parallel bit vector conversion according to parallel processing in a single instruction multiple data (SIMD) method, if an original data sequence is set to be composed of only two values of {0,1} and a bit width per element of a bit vector to be converted is set to be m, m elements of the original data sequence are all converted according to one-time parallel processing in the SIMD method. That is, the number of parallels in the parallel processing in the SIMD method is m. For each of the m elements in parallel, values are bit-shifted to corresponding bit positions within one element to be converted, and then these m values are set to one element to be converted by a bit logical sum. The maximum number of parallels of an SIMD-type processor ranges from hundreds to thousands, but, on the other hand, an integer type that a processor can handle without using a special data structure is usually only 64 bits wide at most. For this reason, a bit vector can be generated with only a number of parallels that is much lower than the maximum number of parallels of the SIMD-type processor in a related technology. That is, in parallel bit vector conversion of the related technology, there is a problem that the number of parallels of SIMD is limited to the same number of as the bit width m per element of the bit vector.

An object of each aspect of the present invention is to provide an information processing device, an information processing method, and a program that can solve the problems described above.

### Solution to Problem

To accomplish the object, according to an example aspect of the invention, an information processing device for acquiring a data sequence as an input and outputting a bit vector includes an input data sequence division unit configured to divide the data sequence into a plurality of groups; a bit shift unit configured to shift a digit of a value of data in each of the plurality of groups to a specific digit corresponding to each of the plurality of groups according to parallel processing in a single instruction multiple data (SIMD) method; and a bit setting unit configured to set the value of the data whose digits are shifted by the bit shift unit to corresponding digits of the bit vector.

In addition, according to another example aspect of the invention, an information processing method by an information processing device for acquiring a data sequence as an input and outputting a bit vector, includes dividing the data sequence into a plurality of groups; shifting a digit of a value of data in each of the plurality of groups to a specific digit corresponding to each of the plurality of groups according to parallel processing in a single instruction multiple data (SIMD) method; and setting the value of data whose digits are shifted to corresponding digits of the bit vector.

In addition, according to still another example aspect of the invention, a program that causes a computer of an information processing device for acquiring a data sequence as an input and outputting a bit vector to execute dividing the data sequence into a plurality of groups; shifting a digit of a value of data in each of the plurality of groups to a specific digit corresponding to each of the plurality of groups according to parallel processing in a single instruction multiple data (SIMD) method; and setting the value of the data whose digits are shifted to corresponding digits of the bit vector.

### Advantageous Effects of Invention

According to each aspect of the present invention, the number of parallels in parallel processing of an SIMD method is not limited to a bit width, and it is possible to generate bit vectors at a high speed with a larger number of parallels in the parallel processing in the SIMD method.

### BRIEF DESCRIPTION OF DRAWINGS

FIG. 1 is a diagram showing a configuration of a bit vector generation device according to a first example embodiment of the present invention.

FIG. 2 is a diagram showing an operation of a bit setting unit according to the first example embodiment of the present invention.

FIG. 3 is a diagram showing a processing flow of a bit vector generation device according to the first example embodiment of the present invention.

FIG. 4 is a diagram showing processing of the bit vector generation device according to the first example embodiment of the present invention.

FIG. 5 is a diagram showing a configuration of a data sequence generation device according to another example embodiment of the present invention.

FIG. 6 is a diagram showing a configuration of an aggregate calculation system according to a second example embodiment of the present invention.

FIG. 7 is a diagram showing processing of the aggregate calculation system according to the second example embodiment of the present invention.

FIG. 8 is a diagram showing an example of a data set used for generating a machine learning model in the second example embodiment of the present invention.

FIG. 9 is a diagram showing a configuration of a vector calculation system according to a third example embodiment of the present invention.

FIG. 10 is a diagram showing processing of the vector calculation system according to the third example embodiment of the present invention.

FIG. 11 is a diagram showing a bit vector generation device with a minimum configuration according to the example embodiments of the present invention.

FIG. 12 is a schematic block diagram showing a configuration of a computer according to at least one example embodiment.

### EXAMPLE EMBODIMENTS

### First Example Embodiment

Hereinafter, example embodiments will be described in detail with reference to the drawings.

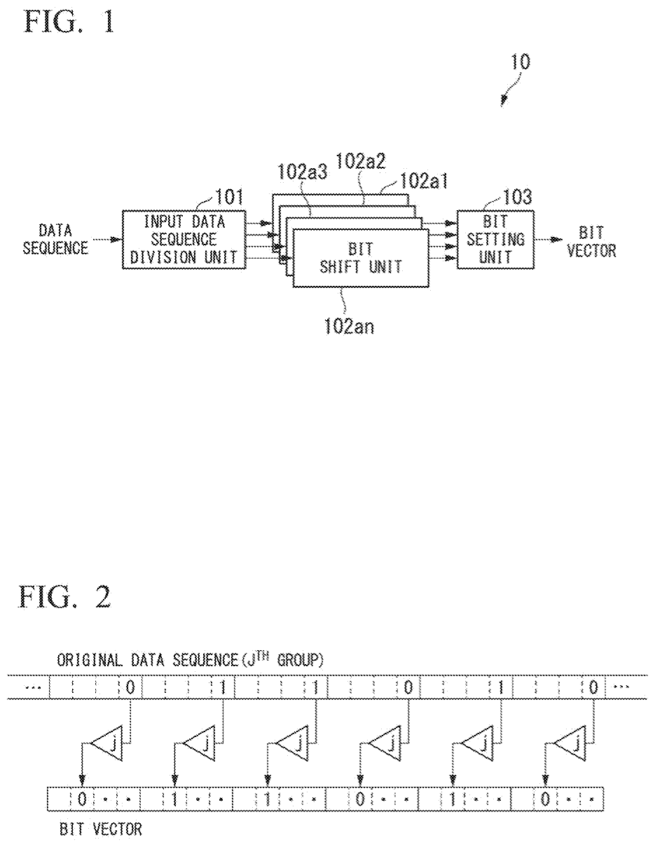

A bit vector generation device 10 (an example of an information processing device) according to a first example embodiment of the present invention includes, as shown in FIG. 1, an input data sequence division unit 101, bit shift units 102a1, 102a2, 102a3, . . . , and 102am, and a bit setting unit 103. The bit shift units 102a1, 102a2, 102a3, . . . , and 102ak are collectively referred to as a bit shift unit 102.

The bit vector generation device 10 is a device included in an SIMD-type processor. Unlike the case of using a related technology of setting a bit width per element of a bit vector to m, and bit-shifting an input data sequence in order from the beginning with a different number of digits for each element, the bit vector generation device 10 is a device that generates an output bit vector that can perform parallel processing in the SIMD method using k parallels by setting the number of elements included in each of m groups to be the same as the number of elements k of the output bit vector.

The input data sequence division unit 101 divides an input data sequence into a plurality of groups. For example, the input data sequence division unit 101 divides a data sequence to be input into m groups such that the input data sequence is composed of continuous elements in a memory. The number of elements included in each of the m groups is the same as the number of elements k of an output bit vector.

Each bit shift unit 102 shifts a digit of the value of data in each of the plurality of groups to a specific digit corresponding to each of the plurality of groups according to the parallel processing in the SIMD method. For example, each bit shift unit 102 bit-shifts each element in one group collectively by one-time parallel processing in the SIMD method. The bit shift unit 102 bit-shifts a value of each element in a group by the same number of digits in the one-time parallel processing in the SIMD method.

The bit setting unit 103 sets the value of the data whose digits are shifted by the bit shift unit 102 to corresponding digits of the output data sequence. For example, the bit setting unit 103 sets a value bit-shifted by each bit shift unit 102 to a corresponding bit position of an output bit vector.

For example, when the original data sequence shown in FIG. 2 is a j^{th} group (j∈{0,1,2, . . . , m−1}), the bit shift unit 102 shifts all of k elements included in the j^{th} group to the left (an upper bit side) by j bits, and the bit setting unit 103 sets the value to a j^{th} bit of each element of the output bit vector.

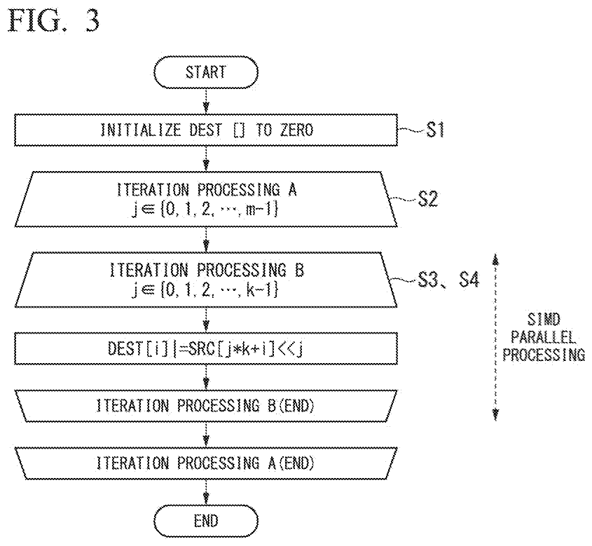

Next, processing of the bit vector generation device 10 according to the first example embodiment of the present invention will be described. Here, a processing flow of the bit vector generation device 10 shown in FIG. 3 will be described. Note that n is the number of elements of an input data sequence, m is the bit width per element of a bit vector, k is the number of elements of an output bit vector, and i is a subscript indicating a position of data in one group. In addition, the number of elements k of a bit vector after conversion can be expressed as k=CEILING(n/m) (CEILING is a ceiling function). Moreover, SRC is an input data sequence, and DEST is an output bit vector.

The bit vector generation device 10 initializes the output bit vector DEST to an initial value of zero (step S1). This initialization may be performed mainly by any one of the input data sequence division unit 101, the bit shift unit 102, and the bit setting unit 103.

The input data sequence SRC is input to the input data sequence division unit 101. The input data sequence division unit 101 divides an input data sequence into a plurality of groups (step S2). For example, the input data sequence division unit 101 divides the input data sequence SRC into m groups in total such that k elements are included in each group in order from the beginning. The operation of this input data sequence division unit 101 corresponds to iterative processing A in the processing flow of FIG. 3, and each group can be represented as a subroutine written as the j^{th} group if an iterative variable j∈{0,1,2, . . . , m−1} is used.

Each bit shift unit 102 shifts the digit of the value of data in each of the plurality of groups to a specific digit corresponding to each of the plurality of groups according to parallel processing in the SIMD method (step S3). For example, each bit shift unit 102 shifts all the elements in the j^{th} group to the left by j bits according to the parallel processing in the SIMD method. The bit setting unit 103 sets the value of data whose digits are shifted by the bit shift unit 102 to corresponding digits of the output data sequence (step S4). For example, the bit setting unit 103 sets these values shifted to the left by j bits to the j^{th} bit of the output bit vector. These operations of the bit shift unit 102 and the bit setting unit 103 correspond to a subroutine according to iteration processing B and internal parallel processing in the SIMD method in the processing flow of FIG. 3. Note that bit setting by the bit setting unit 103 can be performed by a bit OR operation. In addition, the bit setting by the bit setting unit 103 may be performed according to an addition operation of integers.

### Specific Example 1

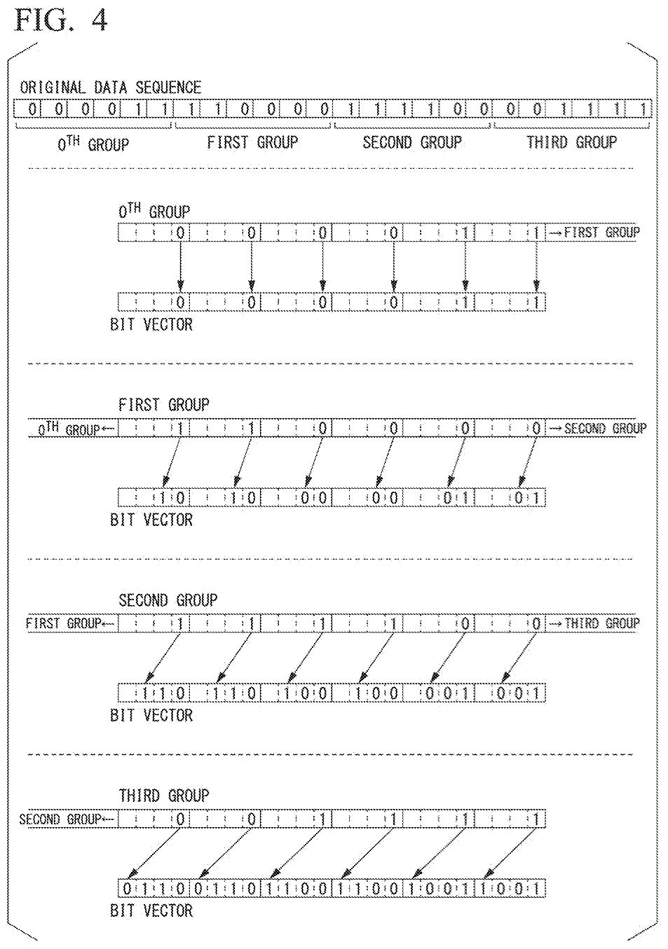

A specific example of processing of the bit vector generation device 10 according to the first example embodiment of the present invention will be described with reference to FIG. 4. The original data sequence SRC to be input is composed of 24 elements (n=24) as shown in FIG. 4. A bit width for each element of the bit vector is assumed to be 4 bits (m=4). The number of elements k of an output bit vector is k=CEILING (24/4)=6.

In the bit vector generation device 10, the input data sequence division unit 101 divides an input data sequence into groups every 6 elements and forms 4 groups in total. The input data sequence division unit 101 sets the groups to a 0^{th} group, a first group, a second group, and a third group in order from the beginning according to a value of the iterative variable j∈{0,1,2, . . . , m−1} described above. In addition, the input data sequence division unit 101 also counts a lowest bit position of a bit vector as a 0^{th} bit. Each bit shift unit 102 does not perform bit-shifting on six elements included in the 0th group (shifting by 0 bits is performed according to the parallel processing in the SIMD method). The bit setting unit 103 sets the values to the 0^{th} bit of each of the six elements of the bit vector. Each bit shift unit 102 shifts all six elements included in the first group to the left by 1 bit according to the parallel processing in the SIMD method. The bit setting unit 103 sets the values to the 1^{st} bit of each of the six elements of the bit vector. The same applies hereinafter, but each bit shift unit 102 shifts all six elements included in the second group to the left by 2 bits according to the parallel processing in the SIMD method, and the bit setting unit 103 sets the values to the 2nd bit of each of the six elements of the bit vector. Finally, each bit shift unit 102 shifts all six elements included in the third group to the left by 3 bits according to the parallel processing in the SIMD method, and the bit setting unit 103 sets the values to the 3^{rd} bit of each of the six elements of the bit vector. The output bit vector DEST is completed according to such processing.

The bit vector generation device 10 according to the first example embodiment of the present invention has been described above. In the bit vector generation device 10 according to the first example embodiment of the present invention, the input data sequence division unit 101 divides an input data sequence into a plurality of groups. Each bit shift unit 102 shifts the digit of the value of data in each of the plurality of groups to a specific digit corresponding to each of the plurality of groups according to the parallel processing in the SIMD method. The bit setting unit 103 sets the value of data whose digits are shifted by the bit shift unit 102 to corresponding digits of the output data sequence.

In this way, the number of parallels in the parallel processing in the SIMD method is not limited to the bit width m, and the bit vector generation device 10 can generate a bit vector at a high speed with a larger number of parallels k in the parallel processing in the SIMD method. In addition, since both the input data sequence SRC and the output bit vector DEST to be processed are continuous elements, memory access can be performed at a high speed, and the bit vector generation device 10 can generate a bit vector at a high speed.

In another example embodiment of the present invention, an order of bits may also be reversed within one element of a bit vector. That is, values may be set either order from a lower bit to an upper bit in order or from the upper bit to the lower bit in order within one element of a bit vector. In the case of a reverse order to description of the operation described above, the bit shift unit 102 may shift all the elements in the j^{th} group to the left by m−j−1 bits.

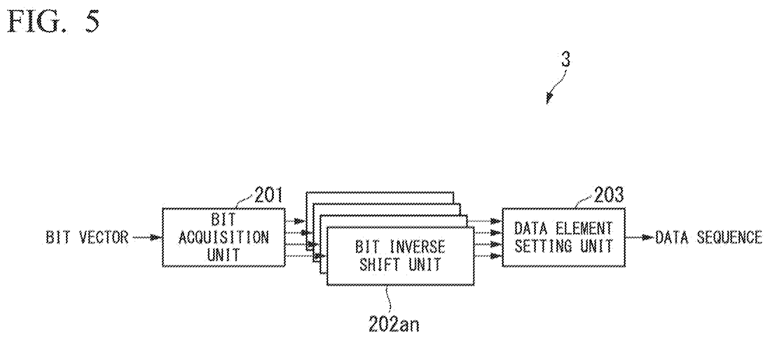

In another example embodiment of the present invention, a data sequence generation device 3 (an example of the information processing device) maybe used to generate a data sequence in an original order using a bit vector as an input, that is, to perform inverse conversion from a bit vector to an original data sequence. That is, the data sequence generation device 3 according to another example embodiment of the present invention is, for example, as shown in FIG. 5, configured from a bit acquisition unit 201, a bit inverse shift unit 202, and a data element setting unit 203. The bit acquisition unit 201 acquires a value of a specific bit position from each element of an input bit vector. The bit inverse shift unit 202 bit-shifts the value of each bit position to a position of a lower bit according to the parallel processing in the SIMD method. The data element setting unit 203 sets the bit-shifted value to each element of a data sequence. In another example embodiment of the present invention, the data sequence generation device 3 may also include the bit acquisition unit 201, the bit inverse shift unit 202, and the data element setting unit 203 mentioned above. The data sequence generation device 3 described above corresponds to a bit vector inverse conversion unit 40 of a bit vector inverse conversion device 2 according to a third example embodiment of the present invention to be described alter.

In the bit vector generation device 10 according to the first example embodiment of the present invention, a data sequence to be input is composed of only two values of {0,1}. However, in another example embodiment of the present invention, the data sequence to be input is not limited to the two values of {0,1}. In another example embodiment of the present invention, the data sequence to be input may be, for example, a discrete value data sequence. Here, the types of values that can be acquired by each element of the data sequence are limited, and a sufficient number of bits t that can express the types of values is considered. For example, when the input data sequence is composed of three values of {0,1,2}, it is sufficient for the number of bits t to be 2 bits. Therefore, if a bit shifting amount of the bit shift unit 102 and a bit setting position of the bit setting unit 103 are changed such that one element of the original data sequence corresponds to a t bit portion of the bit vector, it is possible to generate a bit vector even when a discrete value data sequence is input.

### Second Example Embodiment

Next, an aggregate calculation system 1 (an example of an information processing device) according to a second example embodiment of the present invention will be described.

The aggregate calculation system 1 according to the second example embodiment of the present invention is a system that performs aggregate calculation of a data sequence after generating an output bit vector DEST from the input data sequence SRC.

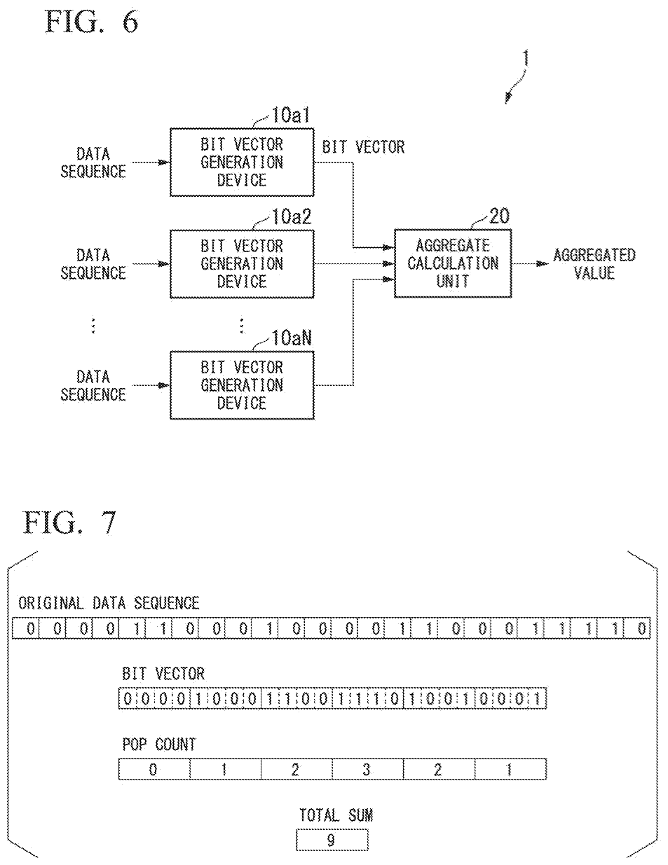

The aggregate calculation system 1 includes bit vector generation devices 10a1, 10a2, . . . , and 10aN, and an aggregate calculation unit 20 as shown in FIG. 6. The bit vector generation devices 10a1, 10a2, . . . , and 10aN are collectively referred to as a bit vector generation device 10a.

Each bit vector generation device 10a is the same as the bit vector generation device 10 according to the first example embodiment of the present invention. Each bit vector generation device 10a generates the output bit vector DEST from the input data sequence SRC and outputs the generated output bit vector DEST to the aggregate calculation unit 20.

The aggregate calculation unit 20 sets the plurality of output bit vectors DEST as an input and performs aggregate calculation on the bit vectors. The aggregate calculation is, for example, calculation of a sum or average value of data sequences, processing of counting the number of elements that satisfy a specific condition in the data sequences, an inner product operation between vectors, a matrix product operation between matrices, and the like.

Next, processing of the aggregate calculation system 1 according to the second example embodiment of the present invention will be described. Note that, since the bit vector generation device 10a is the same as the bit vector generation device 10 according to the first example embodiment of the present invention, the processing of the aggregate calculation unit 20 will be described herein.

The aggregate calculation unit 20 performs an operation equivalent to the operation originally performed on the original input data sequence SRC on the output bit vector DEST. Each bit vector generation device 10a generates an output bit vector DEST in which the order of bits is different from that of a bit vector generated by using a related technology as described in the first example embodiment of the present invention. However, the operations performed by the aggregate calculation unit 20 are operations that are irrelevant to the order of bits, such as sum and inner product. For this reason, the aggregate calculation system 1 can perform correct aggregate calculation. That is, the aggregate calculation system 1 can calculate a correct aggregated value.

For example, the calculation of a total sum of a data sequence composed of only two values of {0,1}, which is performed by the aggregate calculation unit 20, can be realized by counting the number of bits that are 1 in a bit vector. In this case, the operations performed by the aggregate calculation unit 20 may include performing pop counting processing on each element of the output bit vector DEST and calculating a total sum of values calculated by pop counting.

In addition, for example, the inner product operation between vectors composed of only two values of {0,1}, which is performed by the aggregate calculation unit 20, may include performing a bit AND operation on bit vectors, performing pop counting processing on each element of a bit vector, and calculating a total sum of values calculated by pop counting.

### Specific Example 2

A specific example of the processing of the aggregate calculation system 1 according to the second example embodiment of the present invention will be described with reference to FIG. 7. Here, an example in which the aggregate calculation system 1 calculates the total sum of data sequences will be described.

The input data sequence SRC to be input is input to each bit vector generation device 10a. Each bit vector generation device 10a generates an output bit vector DEST from the input data sequence SRC. The aggregate calculation unit 20 performs pop counting processing on each element of the output bit vector DEST generated by each bit vector generation device 10a. A result of the pop counting processing performed by the aggregate calculation unit 20 shows values of 0, 1, 2, 3, 2, and 1 as described after the pop counting in FIG. 7. The aggregate calculation unit 20 calculates the total sum of these values and derives a total sum of 9 as a result of the calculation. In this manner, the aggregate calculation unit 20 derives the same value as the total sum of 9 of the original data sequence in FIG. 7.

The aggregate calculation system 1 according to the second example embodiment of the present invention has been described above. In the aggregate calculation system 1 according to the second example embodiment of the present invention, each bit vector generation device 10a generates the output bit vector DEST from the input data sequence SRC in the same manner as the bit vector generation device 10 according to the first example embodiment of the present invention. The aggregate calculation unit 20 performs an operation equivalent to the operation originally performed on the original input data sequence SRC on the output bit vector DEST.

In this manner, the number of parallels in the parallel processing in the SIMD method is not limited to the bit width m, and the bit vector generation device 10 can generate a bit vector at a high speed with a larger number of parallels k in the parallel processing in the SIMD method, and the aggregate calculation unit 20 performs an operation equivalent to that when a related technology is used on the generated bit vector, the aggregate calculation system 1 can perform an operation at a higher speed than that in an operation by a system using the related technology.

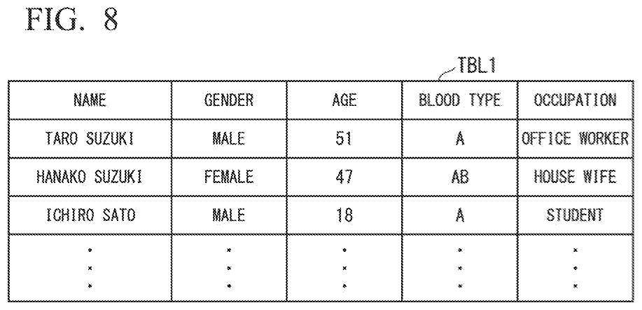

For example, in a data set TBL1 used to generate a model for machine learning, a specific feature may be composed of discrete values. As specific examples, as shown in FIG. 8, there are a case in which 1 is used for men and 0 is used otherwise as a feature indicating a human gender, a case in which 0 is used for an A type, 1 is used for a B type, 2 is used for an 0 type, and 3 is used for an AB type as a feature indicating a human blood type, a case in which 0 is used for office workers, 1 is used for housewives, and 3 is used for students as a feature indicating occupation, and the like. In the generation of a model for machine learning, processing of performing an inner product operation of vectors may be included, but if the feature as described above is treated as a discrete value vector instead of a real vector, it is possible to perform an inner product operation of the discrete value vector using the aggregate calculation system 1. For this reason, the aggregate calculation system 1 can accelerate some or all of the inner product operation of vectors in the generation of a model for machine learning. In this case, the aggregate calculation unit 20 calculates, for an output data sequence (that is, an output bit vector) in which the bit setting unit 103 has set a value of data to a corresponding digit, at least one of a total sum of the output data sequence, an average value of the output data sequence, the number of specific elements in the output data sequence, an inner product between vectors indicated by a plurality of output data sequences, and a matrix product between matrices indicated by the plurality of output data sequences according to the parallel processing in the SIMD method.

It has been described above that the aggregate calculation system 1 according to the second example embodiment of the present invention includes a plurality of bit vector generation devices 10a. However, the aggregate calculation system 1 according to another example embodiment of the present invention may include one bit vector generation device 10a, and the aggregate calculation unit 20 may perform an aggregate calculation on the output bit vector DEST generated by the bit vector generation device 10a.

### Third Example Embodiment

Next, a vector calculation system 2 (an example of the information processing device) according to a third example embodiment of the present invention will be described.

The vector calculation system 2 according to the third example embodiment of the present invention is a system that performs vector calculation of a data sequence after converting the input data sequence SRC into a bit vector. The vector calculation system 2 is a system that has assumed a case in which an order of elements of an original data sequence will be needed later.

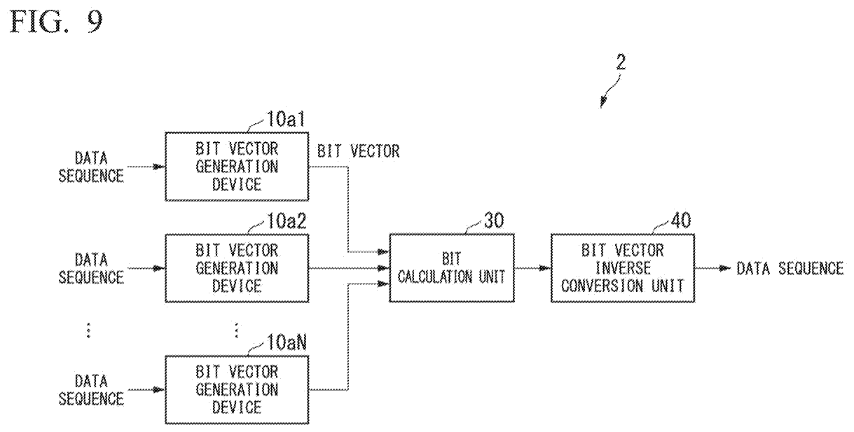

The vector calculation system 2 includes, as shown in FIG. 9, bit vector generation devices 10a1, 10a2, . . . , and 10aN, a bit calculation unit 30, and a bit vector inverse conversion unit 40. The bit vector generation devices 10a1, 10a2, . . . , and 10aN are collectively referred to as a bit vector generation device 10a.

Each bit vector generation device 10a is the same as the bit vector generation device 10 according to the first example embodiment of the present invention. Each bit vector generation device 10a generates an output bit vector DEST from the input data sequence SRC, and outputs the generated output bit vector DEST to the bit calculation unit 30.

The bit calculation unit 30 performs bit calculation on a plurality of bit vectors. The bit calculation is, for example, bit inversion (NOT), bit logical product (AND), bit logical sum (OR), bit exclusive logical sum (XOR), and the like.

The bit vector inverse conversion unit 40 sets a bit vector as an input and generates a data sequence in an original order. That is, the bit vector inverse conversion unit 40 is a functional unit that performs inverse conversion from a bit vector to an original data sequence.

Next, processing of the vector calculation system 2 according to the third example embodiment of the present invention will be described. Note that, since the bit vector generation device 10a is the same as the bit vector generation device 10 according to the first example embodiment of the present invention, processing of the bit calculation unit 30 and the bit vector inverse conversion unit 40 will be described herein.

The bit calculation unit 30 performs a vector calculation equivalent to the vector calculation originally performed on the original input data sequence SRC on the output bit vector DEST.

The bit vector inverse conversion unit 40 performs a reverse operation of the bit vector generation device 10 to restore the order of the elements of the data sequence. For this reason, the vector calculation system 2 according to the third example embodiment of the present invention can obtain a correct calculation result.

For example, multiplication between data sequences composed of only two values of {0,1} by the vector calculation system 2 for each element (a so-called Hadamard product) can obtain the same result according to a bit AND operation between bit vectors. Processing of the bit calculation unit 30 in this case includes processing of performing a bit AND operation on each element of the bit vectors.

### Specific Example 3

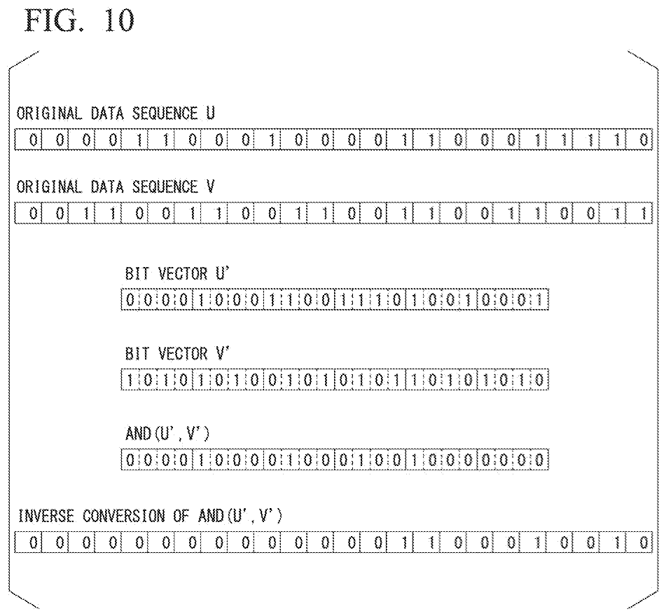

A specific example of the processing of the vector calculation system 2 according to the third example embodiment of the present invention will be described with reference to FIG. 10. Here, an example in which the vector calculation system 2 calculates the multiplication of a data sequence U and a data sequence V for each element will be described.

Each bit vector generation device 10a generates a bit vector U′ and a bit vector V′ from the data sequence U and the data sequence V to be input (refer to the bit vector U′ and the bit vector V′ in FIG. 10). The bit calculation unit 30 calculates a bit logical product AND (U′,V′) of these two bit vector U′ and bit vector V′ (refer to AND (U′,V′) in FIG. 10). The bit vector inverse conversion unit 40 inversely converts this bit vector AND (U′,V′) into a data sequence in an original order (refer to the inverse conversion of AND (U′,V′) in FIG. 10). As seen from FIG. 10, a result of the inverse conversion of the AND (U′,V′) by the vector calculation system 2 is the same as a result of multiplication of the data sequence U and the data sequence V for each element.

As described above, the vector calculation system 2 according to the third example embodiment of the present invention has been described. In the vector calculation system 2 according to the third example embodiment of the present invention, each bit vector generation device 10a generates the output bit vector DEST from the input data sequence SRC in the same manner as the bit vector generation device 10 according to the first example embodiment of the present invention. The bit calculation unit 30 performs vector calculation equivalent to the vector calculation originally performed on the original input data sequence SRC on the output bit vector DEST. The bit vector inverse conversion unit 40 performs a reverse operation of the bit vector generation device 10 to restore the order of the elements of the data sequence.

In this manner, since the number of parallels in the parallel processing in the SIMD method is not limited to the bit width m, the bit vector generation device 10 can generate a bit vector at a high speed with a larger number of parallels k in the parallel processing in the SIMD method, and, since the bit calculation unit 30 performs an operation equivalent to when a related technology is used on the generated bit vector, the vector calculation system 2 can perform an operation at a higher speed than in the operation by a system using the related technology.

For example, a case in which a WHERE phrase of a query in a selection operation of a database is composed of a plurality of conditions is considered. Here, a boolean sequence vector having values such that 1 is used for a line (record) matching the conditions, and 0 is used otherwise is considered. At this time, boolean sequence vectors corresponding to individual conditions are used as intermediate results, and a boolean sequence vector corresponding to an entire WHERE phrase is used as a final result. If a specific example is given, for example, when the WHERE phrase is “age>50 AND gender=male AND blood type=A type,” the intermediate results are a boolean sequence vector indicating whether the age is 50 or older, a boolean sequence vector indicating whether the gender is male, and a boolean sequence vector indicating whether the blood type is an A type, and the final result is a boolean sequence vector indicating whether the entire WHERE phrase is matched. In such a case, it is possible to perform a vector logical operation for obtaining the final result from an intermediate result group using the vector calculation system 2. For this reason, the vector calculation system 2 can accelerate an acquisition of the final result in the selection operation of a database.

A bit vector generation device 10 with a minimum configuration according to the example embodiments of the present invention will be described.

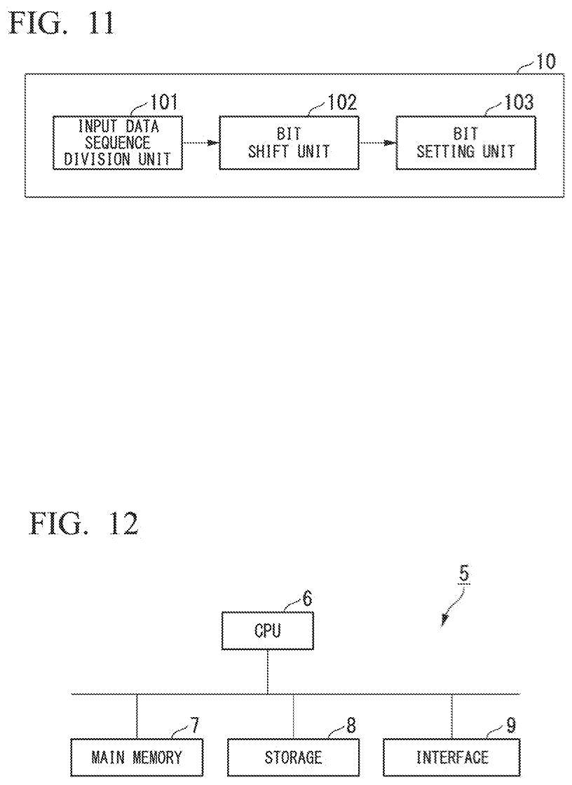

The bit vector generation device 10 with a minimum configuration according to the example embodiments of the present invention includes, as shown in FIG. 11, an input data sequence division unit 101, a bit shift unit 102, and a bit setting unit 103.

The input data sequence division unit 101 divides an input data sequence into a plurality of groups.

The bit shift unit 102 shifts the digit of the value of data in each of the plurality of groups to a specific digit corresponding to each of the plurality of groups by parallel processing in the SIMD method.

The bit setting unit 103 sets the value of the data whose digits are shifted by the bit shift unit 102 to corresponding digits of the output data sequence.

The bit vector generation device 10 is configured in this manner, and thereby the number of parallel in parallel processing in the SIMD method is not limited to a bit width m and the bit vector generation device 10 can generate a bit vector at a high speed with a larger number of parallels k in the parallel processing in the SIMD method. In addition, since both the input data sequence SRC and the output bit vector DEST to be processed are continuous elements, memory access can be performed at a high speed, and the bit vector generation device 10 can generate a bit vector at a high speed.

In the processing according to the example embodiment of the present invention, an order of the processing may be changed as long as appropriate processing is performed.

Each of the storage unit and other storage devices (including latches, registers, and the like) in the example embodiment of the present invention may be provided anywhere within a range in which appropriate information is transmitted or received. In addition, the storage unit and other storage devices may be present in plural within a range in which appropriate information is transmitted or received, and may distribute and store data.

The example embodiments of the present invention have been described, but the bit vector generation devices 10 and 10a, the aggregate calculation unit 20, and other control devices described above may have a computer system therein. Then, a process of the processing described above is stored in a computer-readable recording medium in a form of a program, and the processing described above is performed by a computer reading and executing this program. A specific example of the computer is shown below.

FIG. 12 is a schematic block diagram which shows a configuration of a computer according to at least one example embodiment.

A computer 5 includes, as shown in FIG. 12, a CPU 6, a main memory 7, a storage 8, and an interface 9.

For example, each of the bit vector generation devices 10 and 10a, the aggregate calculation unit 20, and other control devices described above is mounted on a computer 5. Then, an operation of each processing unit described above is stored in the storage 8 in a form of a program. The CPU 6 reads a program from the storage 8, develops the program onto the main memory 7, and executes the processing described above according to the program. In addition, the CPU 6 secures a storage area corresponding to each storage unit described above in the main memory 7 according to the program.

Examples of the storage 8 may include a hard disk drive (HDD), a solid state drive (SSD), a magnetic disk, a magneto-optical disc, a compact disc read only memory (CD-ROM), a digital versatile memory (DVD-ROM), a semiconductor memory, and the like. The storage 8 may be an internal media directly connected to a bus of the computer 5, or may be an external media connected to the computer 5 via the interface 9 or a communication line. In addition, when the program is delivered to the computer 5 by a communication line, the computer 5 having delivered the program may develop the program onto the main memory 7, and execute the processing described above. In at least one example embodiment, the storage 8 is a non-temporary tangible storage medium.

Moreover, the program described above may realize some of the functions described above. Furthermore, the program may be a file that can realize the functions in combination with a program already recorded in a computer system, which is a so-called difference file (a difference program).

Although some example embodiments of the present invention have been described, these example embodiments are examples and do not limit the scope of the invention. Various additions, omission, replacements, and changes may be made in these example embodiments in a range not departing from the gist of the invention.

### INDUSTRIAL APPLICABILITY

According to each aspect of the present invention, the number of parallels in the parallel processing in the SIMD method is not limited to the bit width m, and it is possible to generate a bit vector at a high speed with a larger number of parallels k in the parallel processing in the SIMD method.

### REFERENCE SIGNS LIST

1 Aggregate calculation system
5 Computer
6 CPU
7 Main memory
8 Storage
9 Interface
10, 10a, 10a1, 10a2, 10aN Bit vector generation device
20 Aggregate calculation unit
101 Input data sequence division unit
102, 102a1, 102a2, 102a3, 102an Bit shift unit
103 Bit setting unit
201 Bit acquisition unit
202 Bit inverse shift unit
203 Data element setting unit

What is claimed is:

1. An information processing device for acquiring a data sequence as an input and outputting a bit vector, comprising:
a memory configured to store instructions; and
a processor configured to execute the instructions to:
divide the data sequence into a plurality of groups;
shift a digit of a value of data in each of the plurality of groups to a specific digit corresponding to each of the plurality of groups according to parallel processing in a single instruction multiple data (SIMD) method; and
set the value of the data whose digits are shifted to corresponding digits of the bit vector.

2. The information processing device according to claim 1,
wherein the processor is configured to execute the instructions to: perform aggregate calculation including at least one of a sum of the bit vector, an average value of the bit vector, a number of specific elements in the bit vector, an inner product between vectors indicated by a plurality of bit vectors, and a matrix product between matrices indicated by the plurality of bit vectors on a bit vector set in which the value of the data to corresponding digits has been set.

3. The information processing device according to claim 1,
wherein the processor is configured to execute the instructions to:
acquire a value of a specific bit position from each element of the bit vector in which the value of the data to be a corresponding digit has been set;
shift a digit of each acquired value of the bit position to a position of a lower bit according to parallel processing of the SIMD; and
set a value whose digits are shifted unit to each element of a data sequence.

4. The information processing device according to claim 1,
wherein the input data sequence is a data sequence in which a feature that is expressed by a discrete value is expressed by a discrete value vector in model generation of machine learning.

5. The information processing device according to claim 1,
wherein an input data sequence is a Boolean vector that expresses whether or not a line matches a condition of a query in a selection operation in a table operation of a database.

6. An information processing device comprising:
a memory configured to store instructions; and
a processor configured to execute the instructions to:
acquire a value of a specific bit position from each element of a bit vector;
shift a digit of each acquired value of the bit position to a position of a lower bit according to parallel processing of single instruction multiple data (SIMD); and
set a value whose digits are shifted to each element of a data sequence.

7. An information processing method executed by an information processing device for acquiring a data sequence as an input and outputting a bit vector, comprising:
dividing the data sequence into a plurality of groups;
shifting a digit of a value of data in each of the plurality of groups to a specific digit corresponding to each of the plurality of groups according to parallel processing in a single instruction multiple data (SIMD) method; and
setting the value of data whose digits are shifted to corresponding digits of the bit vector.

8. (canceled)
